(19) United States
(12) Patent Application Publication
(10) Pub. No.: US 2008/0096508 A1
(43) Pub. Date: Apr. 24, 2008

(54) Low Intermediate Frequency (If) Radio Receiver Circuits

(75) Inventor: Gwilym Francis Luff, Cambridgeshire (GB)

Correspondence Address: SCHWEGMAN, LUNDBERG & WOESSNER, P.A., P.O. BOX 2938, MINNEAPOLIS, MN, 55402, US

(73) Assignee: Frontler Silicon Limited, Cmbridge Cambridgeshire (GB)

(21) Appl. No.: 11/663,367

(22) PCT Filed: Sep. 12, 2005
(86) PCT No.: PCT/GB05/50150

§ 371 Date: Dec. 20, 2007

(30) Foreign Application Priority Data
Sep. 20, 2004 (GB) 0420842.7

(51) Int. Cl. H04B 1/16

(52) U.S. Cl. 455/209

(57) ABSTRACT

This invention relates to apparatus and methods for radio receivers, in particular low (IF) frequency receivers. Embodiments of the invention are particularly suitable for digital audio broadcast receivers. A low-IF radio receiver circuit, the circuit comprising: an rf input for a received rf signal; a first local oscillator having a quadrature output to provide a quadrature first local oscillator signal at a first frequency; a quadrature first mixer coupled to said rf input and to said quadrature-output of said first local-oscillator and having a quadrature first mixer output, and said first mixer and said first local oscillator being configured to provide quadrature mixing of said quadrature first local oscillator signal and said received rf signal to downconvert said received rf signal to a first quadrature IF Signal at a first IF frequency; a bandpass filter coupled to said quadrature first mixer output and having a filtered output to provide a bandpass filtered first IF signal; a second local oscillator having a second local oscillator output to provide a second local oscillator signal at a second frequency; a second mixer coupled to said filtered output of said bandpass filter and to said second local oscillator and having a second mixer output, said second mixer and said second local oscillator being configured to provide mixing of said second local oscillator signal and said bandpass filtered first IF signal to up-convert said bandpass filtered first IF signal to a second IF signal at a second IF frequency, wherein said second IF frequency is greater than said first IF frequency; and an output coupled to said second mixer output to provide an output signal from said second IF signal.

This invention relates to apparatus and methods for radio receivers, in particular so-called low (IF) frequency receivers. Embodiments of the invention are particularly suitable for digital audio broadcast receivers.

Intermediate frequency receivers have been in use for many years, the best known example of such a receiver being the superheterodyne receiver. In a superhet receiver the desired or target rf signal is downconverted to an intermediate frequency by mixing or multiplying the received signal by a simple sinusoidal signal from a local oscillator. The desired or target rf signal can be demodulated at this intermediate frequency or further downcoverted prior to modulation. A plurality of successive downconversion stages may be employed.

The local oscillator frequency is selected to be equal to a difference between the frequency of the target rf signal and the intermediate frequency. However the mixing process results in an unwanted response to a so-called image signal, the target and image signals lying, on opposite sides of the local oscillator frequency. Thus a conventional superhet includes a high Q image reject filter prior to the mixer, or a tunable receiver, which must itself be tunable. Such a high Q filter is difficult and expensive to fabricate and because, a combination of capacitors and inductors is normally required, difficult to integrate.

In recent years single chip integrated radio receivers have been fabricated in CMOS by employing a zero-IF topology. Such a receiver is also known as a homodyne or direct conversion receiver. In a zero-IF receiver the IF frequency is chosen to be zero so that the target and image coincide. This relaxes the image rejection ratio requirements and dispenses with the need for an off-chip image reject filter. However it is then necessary to, in effect, capture the spectrum to either side of dc, which is done by employing quadrature downconversion, that is by employing a local oscillator with a quadrature (sine and cosine) output and a quadrature mixer to provide a pair of IF signals, one in phase quadrature with the other. By employing quadrature signal processing positive and negative frequency components can be separated.

The main advantage of a zero-IF receiver is that this topology dispenses with the need for a high Q, tunable, bandpass filter prior to the mixer; instead a low-pass filter is employed once the received signal has been downconverted. However this architecture suffers from a number of drawbacks including dc offsets in the downconverted signal due to self-mixing (the receiver receiving signals from its own local oscillator), second-order distortion due to mixer non-linearity, and 1/f (dc) noise. An example of a zero-IF receiver is described in U.S. Pat. No. 4,653,117, which describes the use of a phase lock technique to precisely centre the zero-IF signal to avoid problems such as a beat note which arises when the IF frequency is not exactly zero.

More recently it has been recognized that so-called low-IF receivers can overcome the above mentioned drawbacks of direct conversion receivers (Low-IF receivers are sometimes also referred to as near-zero IF receivers, and in this specification the two terms are used synonymously). A low-IF receiver has an IF frequency which is between 0.1 and 10 times the bandwidth of the target rf signal, more typically less than 5, less than 3, or between 1 and 2 times the bandwidth of the target rf signal. At first sight it would appear that such a configuration would require an image reject filter before the mixer with an impossibly high Q but it was recognized that, in fact, rf image rejection could be postponed to the IF stage.

Two basic techniques are known. The first is to use an image-rejecting I/Q mixer that provides quadrature outputs to a pair of separate, matched IF filters. These introduce an additional 90 degrees phase shift between the target and image signals, so that when the filtered signals are combined the image signals are 180 degrees out of phase with one another and cancel. However a preferred technique, which reduces the filter matching requirement, is to filter the quadrature mixer output using a so-called polyphase filter. A polyphase filter receives an n-phase (or polyphase) input and provides an n-phase output; a quadrature filter is a special case of this where n=4.

A polyphase filter distinguishes between positive and negative frequencies, that is it has a frequency response which depends upon a phase difference between its two (or more) input signals. Thus a polyphase bandpass filter can be employed which has a passband centred on the target and which rejects the image signal. Since, in a low-IF receiver, the received signal bandwidth is comparable with the IF frequency only a low Q filter (say Q=1 or 2) is required. Furthermore, unlike a conventional low-Q band pass filter, the frequency response is substantially symmetrical about a centre frequency of the pass band which, for a data receiver, helps to maintain an undistorted eye diagram for the received data. Further, a polyphase filter can be constructed using only resistors and capacitors, that is without inductors, making it suitable for monolithic integration.

Examples of polyphase filters are described in U.S. Pat. No. 6,441,682 and U.S. Pat. No. 4,914,408; background information on polyphase filters can also be found in “Using Polyphase Filters as Image Attenuators”, RF Design, June 2001, pages 26-34, Tom Hornack.

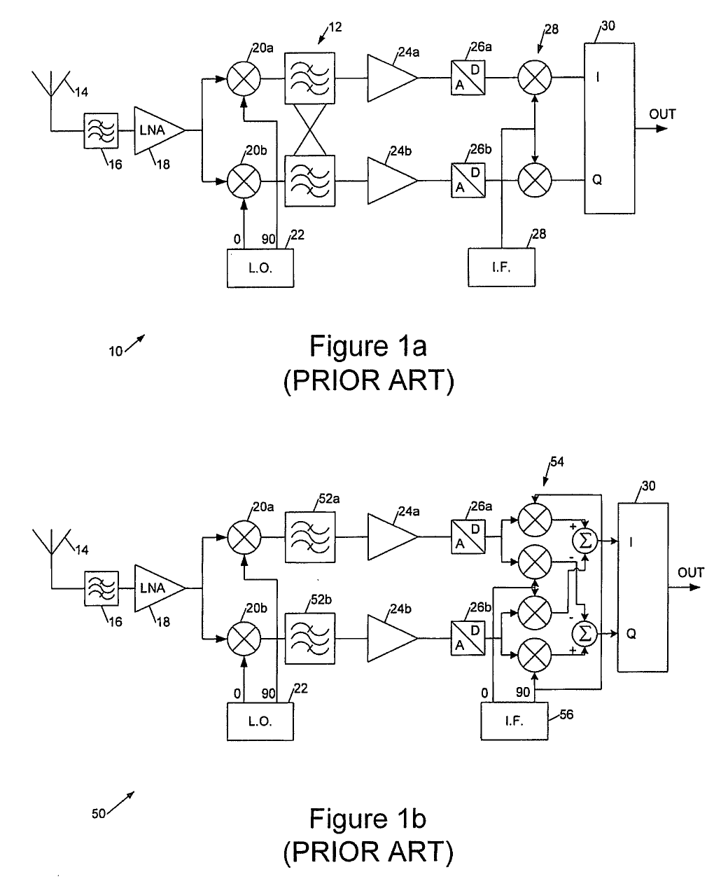

Referring to FIGS. 1a and 1e these show example topologies of a known low-IF receiver, FIG. 1a showing a receiver 10 incorporating a polyphase filter 12, and FIG. 1b showing a receiver 50 which uses a pair of band pass IF filters 52a, b in the IF processing. Both receivers comprise a receive antenna 14 coupled to a band select filter 16 and low noise amplifier 18, followed by a quadrature downconversion mixer 20a, b, which also has a quadrature input from a local oscillator 22. In the receiver 10 of FIG. 1a quadrature mixer 20 is followed by the polyphase (quadrature) mixer 12 and then by a pair of further amplifiers 24a, b and a pair of analog-to-digital converters 26a, b. There is a similar arrangement in the receiver 50 of FIG. 1b except that a matched pair of IF filters 52a, b is employed. However in the digital domain, in receiver 10 an IF oscillator 28 provides a single phase output at the IF frequency for a pair of mixers 28 to downconvert to base band prior to demodulation 30, whereas in receiver 50 a complex mixer 54 is employed to mix the IF signal with a quadrature signal at the IF frequency from oscillator 56 prior to demodulation 30.

There exists a general need to improve upon these known low-IF receiver topologies, more particularly by aiming to improve image and/or interference rejection whilst reducing the filtering requirements in the analog domain.

According to the present invention there is therefore provided a low IF radio receiver circuit, the circuit comprising: an rf input for a received rf signal; a first local oscillator having a quadrature output to provide a quadrature first local oscillator signal at a first frequency; a quadrature first mixer coupled to said rf input and to said quadrature output of said first local oscillator and having a quadrature first mixer output, said first mixer and said first local oscillator being configured to provide quadrature mixing of said quadrature first local oscillator signal and said received rf signal to downconvert said received rf signal to a first quadrature IF signal at a first IF frequency; a bandpass filter coupled to said quadrature first mixer output and having a filtered output to provide a bandpass filtered first IF signal; a second local oscillator having a second local oscillator output, to provide a second local oscillator signal at a second frequency; a second mixer coupled to said filtered output of said bandpass filter and to said second local oscillator and having a second mixer output, said second mixer and said second local oscillator being configured to provide mixing of said second local oscillator signal and said bandpass filtered first IF signal to up-convert said bandpass filtered first IF signal to a second IF signal at a second IF frequency, wherein said second IF frequency is greater than said first IF frequency; and an output coupled to said second mixer output to provide an output signal from said second IF signal.

As will be explained in more detail below, by employing two IF frequencies, the first IF frequency being lower than the second IF frequency, the image response can be kept close to a desired or target receive channel, whilst at the same time reducing the constraints on the anti-alias and image filtering in the analog domain prior to analog-to-digital conversion. The latter aim (reducing filter constraints) is facilitated by an increased IF frequency since, as will be explained below, this reduces the sharpness of the analog filtering cut-off needed. The former aim (keeping the image response close to the wanted channel) may appear paradoxical since it might be imagined that this would make filtering more difficult. However the constraint can be understood by recognizing that, in a practical system, it is frequently the case that the interference rejection required increases with frequency separation from the selected channel, and for this reason keeping the image response close to wanted channel can actually reduce the filtering requirements.

In preferred embodiments of the receiver circuit the band pass filter provides a quadrature output, and the second mixer is a quadrature mixer, receiving a quadrature input from the band pass filter and a quadrature input from the second local oscillator and providing a quadrature output at the second IF frequency. The circuit may then further comprise a combiner in particular a summer, to sum the quadrature signals at the second IF frequency to provide a single (phase) or real (rather than complex) summed output. This is preferably low-pass filtered to provide an IF output for analog-to-digital conversion. In this way a single analog-to-digital converter may be employed. Furthermore separation between the desired signal and aliases can be improved by selecting the second IF frequency to be an even fraction, more particularly one quarter of the A/D sample frequency.

Preferably the band pass filter comprises a polyphase band pass filter having a pass band response for a target rf signal and an attenuating response for an image signal associated with the target. More particularly, the polyphase band pass filter is preferably centred on a positive frequency equalled to the first IF frequency. However in alternative arrangements a pair of bandpass filters forming part of an image rejecting I/Q mixer may be employed, in which case two real filters rather than a complex (polyphase) filter may be used. In such an embodiment the above-described summer maybe dispensed with, and the IF signal processed (and digitized) as a quadrature pair of signals, along similar lines to that shown in FIG. 1b.

In one preferred embodiment of the receiver circuit the second IF frequency is substantially twice the first IF frequency and, for a DAB (digital audio broadcast) receiver the first and second IF frequencies may be 1.024 MHz and 2.048 MHz respectively. The bandwidth requirements of DAB and the interference rejection required makes embodiments of the circuit particularly suitable for this application. In preferred embodiments the topology is arranged such that the circuit can be integrated on a single chip.

In a corresponding aspect the invention provides a method a method of receiving an rf signal using a low IF receiver, the method comprising: inputting said rf signal; downconverting said rf signal to a first, non-zero IF frequency, said first IF frequency being less than ten times a bandwidth of said rf signal; filtering said downconverted rf signal; upconverting said filtered downconverted rf signal to a second IF frequency, said second IF frequency being higher than said first IF frequency; and providing said upconverted signal for demodulation.

Preferably the filtering comprises band pass filtering to select a target RF signal to attenuate an image signal as previously described. Again as previously described, preferably the downconverting, filtering, and up converting operations are preferably performed on quadrature signals, which are then combined, and preferably low pass filtered, prior to demodulation. Preferably the rf signal comprises a data signal and the first IF frequency is less than three times the bandwidth of this signal; preferably the second IF frequency is substantially twice the first IF frequency. The method further includes converting the combined quadrature signals at the second IF frequency to the digital domain using an analog-to-digital converter operating at an even multiple of the second IF frequency.

The invention further provides a low IF signal receiver for receiving an rf signal, said receiver comprising: means for inputting said rf signal; means for downconverting said rf signal to a first, non-zero IF frequency, said first IF frequency being less than ten times a bandwidth of said rf signal; means for filtering said downconverted rf signal; means for upconverting said filtered downconverted rf signal to a second IF frequency, said second IF frequency being higher than said first IF frequency; and means for providing said upconverted signal for demodulation.

These and other aspects of the first invention will now be further described, by way of example only, with reference to the accompanying figures in which:

FIGS. 1a and 1b show low-IF receivers employing a polyphase bandpass filter and a pair of real bandpass filters respectively;

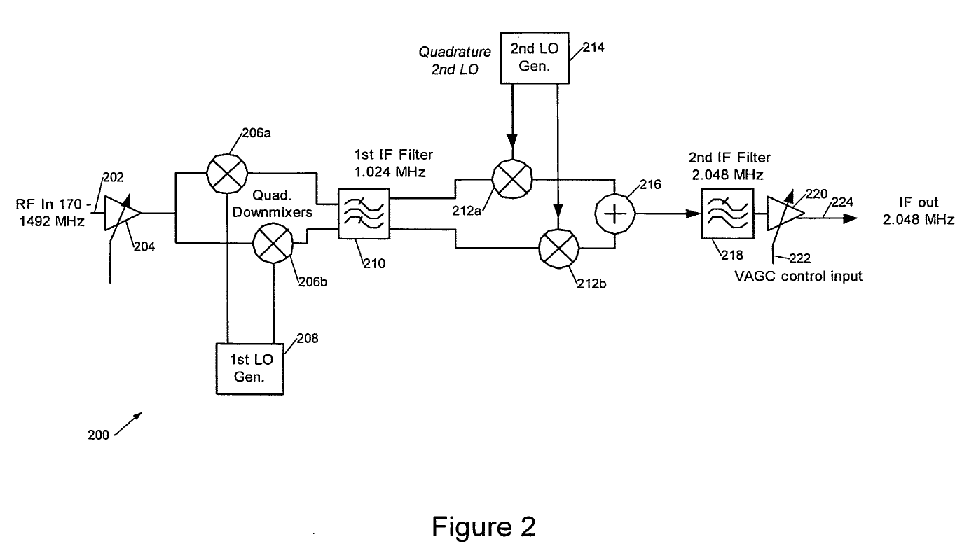

FIG. 2 shows a block diagram of an IF stage frequency conversion circuit for a low-IF frequency receiver according to an embodiment of the present invention;

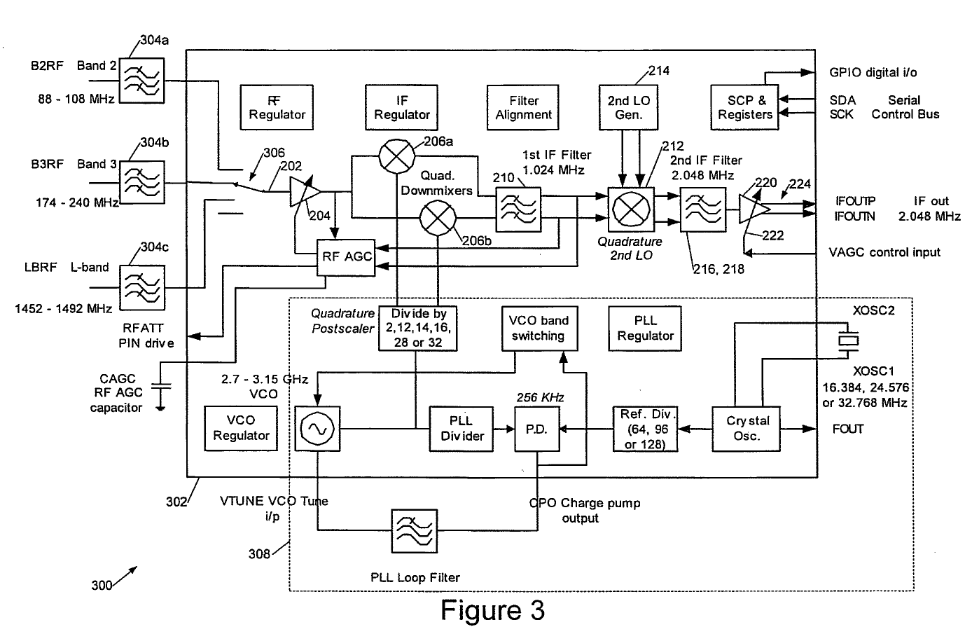

FIG. 3 shows a block diagram of a low-IF receiver integrated circuit incorporating the IF frequency conversion system of FIG. 2; and

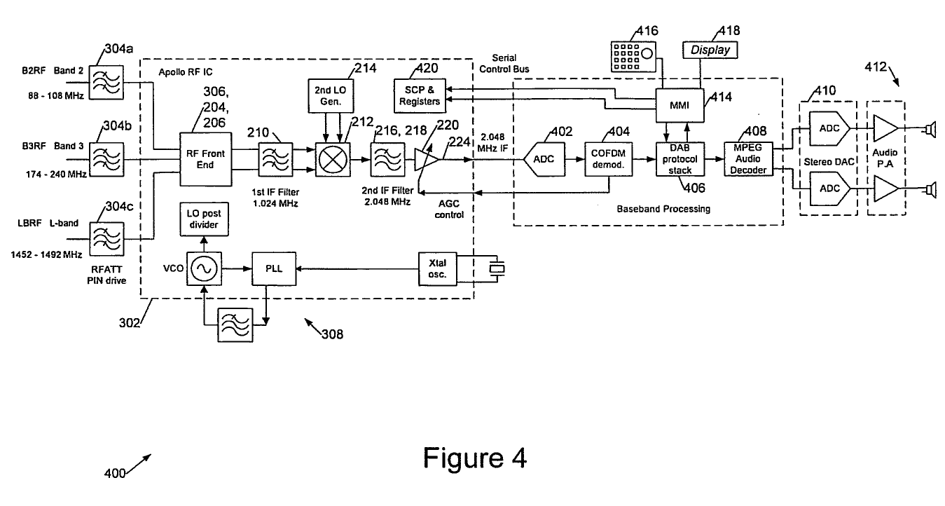

FIG. 4 shows an example of a low-IF digital audio broadcast receiver incorporating the integrated circuit of FIG. 3.

Background information on digital audio broadcast services can be found in the EUREKA-147 standard (ETSI Document EN300 401V1.3.3 (2001-5); reference may also be made to BS EN 50248.2001. Digital audio broadcast services, for example, are provided in two frequency bands, 174-240 MHz (Band 3 in the UK) and 1452-1492 MHz (L Band) for the rest of the world; it is also useful for a DAB receiver to be capable of receiving conventional FM (Frequency Modulation) broadcasts, in the UK at 88-108 MHz.

As mentioned above, a conventional near zero IF receiver has a single low intermediate frequency which is comparable to the signal bandwidth. For the embodiment of the DAB receiver which we will describe the signal bandwidth is 1.536 MHz, however there are two conflicting requirements on the choice of low-IF frequency.

There is a first requirement which makes it beneficial to use lower (but still non-zero) IF frequencies. This requirement arises because the image response of a near zero IF receiver appears at an adjacent (or nearby) channel frequency and because, in many practical systems, the interference rejection required increases with frequency separation from the desired or target channel. For example, for a DAB receiver 35 dB attenuation is required up to 5 MHz from the desired channel, with 50 dB attenuation thereafter. Thus, for example, a 1.024 MHz IF frequency entails an image centred 2.048 MHz away (that is just the other side of dc), extending from 1.28 MHz to 2.816 MHz. This frequency range requires only 35 dB of attenuation, so only 35 dB of image rejection is required. However were an IF frequency of 2.048 MHz to be chosen, this would entail an image centred at 4.192 MHz away, extending from 3.424 MHz to 4.96 MHz. In this case there is an overlap between the outermost OFDM (Orthogonal Frequency Division Multiplexed) bin of the DAB signal at 4.96 MHz and an FM modulated interferer at 5 MHz+/−100 KHz. This scenario would therefore require an image rejection of 50 dB. However this would require a multiple pole filter which would have a relatively high power consumption and occupy a relatively large on-chip area; furthermore the power consumption and noise figure of an on-chip band pass filter both increase in proportion to the centre frequency.

The second, conflicting requirement is for an IF frequency which is high enough to be able to make efficient use of a single ADC (Analog-to-Digital Converter). A single ADC gives the best separation between the wanted signal and aliases (that is frequencies which are higher than the Niquist limit which are folded back into the frequency band) when the IF frequency is one quarter of the ADC sampling frequency. For DAB the lowest possible sampling frequency (for a single ADC) is 4.192 MHz; this is determined by the highest frequency components in the signal in which it is necessary to capture. An IF frequency of one quarter of this value, that is 1.024 MHz, requires very sharp cut-off anti-alias and image filtering in the analog domain, which consumes both power and chip area. The next convenient sampling frequency is 8.192 MHz, which requires a fairly modest anti-alias filtering, and which entails an optimum IF frequency of 2.048 MHz, which avoids over-burdensome image filtering.

For these reasons, as will be described further below, a preferred embodiment of a low-IF receiver for digital audio broadcasting has the frequency plan shown in table 1 below.

TABLE 1
Frequency plan

| | |
|---|---|
| RF input | 170-240 MHz or 1452-1492 MHz |
| First local oscillator frequency | RF frequency + 1.024 MHz |
| First IF frequency | 1.024 MHz |
| Second local oscillator frequency | 1.024 MHz |
| Second IF frequency | 2.048 MHz |

This frequency plan covers both Band 3 and L Band DAB signals. The precise selection of IF frequencies of 1.024 MHz and 2.048 MHz is chosen for optimum sampling of the DAB OFDM signal, and also to conveniently interface with existing base band integrated circuits which are designed for an IF input at 2.048 MHz.

In the above frequency plan, selecting the first IF frequency to be at 1.024 MHz keeps the image response close to the wanted channel, and then using a second, higher IF frequency of 2.048 MHz reduces the amount of analog filtering required and facilitates a clean interface to base band signal processing circuitry.

Referring now to FIG. 2, this shows a block diagram of a frequency conversion system 200 to implement the above described frequency plan.

The signal path begins with an rf input 202 at a frequency (in this example) of between 170 MHz and 1492 MHz, and this is provided to a variable gain LNA (low noise amplifier) 204. A particularly preferred LNA implementation is described in the applicant's co-pending UK Patent Application No. ______ filed on the same day as this application and hereby incorporated by reference.

The output of LNA 204 drives a quadrature downconversion mixer 206a, b, which receives quadrature inputs from a first local oscillator frequency generator 208; in general this will be tunable. The output of quadrature downconversion mixer 206 is a quadrature (I and Q) signal at the first IF frequency, and this signal is provided to a first IF filter 210. Which comprises quadrature polyphase band pass filter centred at the first IF frequency. This filter passes positive frequency signals and attenuates negative frequency signals—that is it passes signals at the first IF frequency +1.024 MHz, but attenuates signals at −1.024 MHz.

The output of polyphase IF filter 210 is a quadrature signal at the first IF frequency, and this provided to a quadrature upconversion mixer 212a, b which performs a quadrature upconversion to the second IF frequency of 2.048 MHz. Quadrature upconversion mixer 212 also receives a quadrature local oscillator signal from second local oscillator signal generator 214, which provides a quadrature output at 1.024 MHz.

The quadrature outputs from mixer 212, at the second IF frequency, are combined in summer 216 and thence provided to a second IF filter 218 comprising a (real) low pass filter with a 3 dB roll-off at the second IF frequency of 2.048 MHz. The output of this filter is then provided to an automatic gain control (AGC) device 220 which applies a controllable gain/attenuation in response to a (voltage) signal on control input 222. The output 224 of AGC 220 provides a single phase (opposed to quadrature) IF output at 2.048 MHz; this may then be provided to an ADC and subsequent digital signature processing circuitry for final down-conversion and demodulation in a conventional manner as outlined in FIG. 1a. Similarly the AGC 220 may be controlled by this DSP circuitry in a conventional mariner (as is well known to those skilled in the art) to increase the dynamic range of the receiver.

In a preferred implementation the quadrature downconversion mixer 206 comprises a pair of Gilbert cell mixers of conventional design, with their rf inputs fed in parallel and their local oscillator inputs fed from the I and Q outputs of quadrature local oscillator generator 208. Preferably the polyphase band pass filter 210 is of a type described by Michiel Steyaert in “A Single Chip 900 MHz CMOS Receiver Front-End with a High Performance Low-IF Topology,” IEEE Journal of Solid State Circuits, Vol. 30, No. 12, December 1995, pp. 1483-1492; and Jan Crols, Michiel Steyaert “An Analog Integrated Polyphase Filter for a High Performance Low-IF Receiver” Proceedings of the VLSI Circuit Symposium Kyoto, June 1995, pp. 87-88; the entire contents of which are hereby incorporated by reference. The second mixer 212 may be implemented in a similar way to the first mixer 206. The second quadrature local oscillator generator 214 may likewise be implemented using any one of a range of conventional means well known to those skilled in the art.

The circuit 200 of FIG. 2 may be implemented in a single integrated circuit and in this case all the signal paths are preferably differential (as is common in rf integrated circuits). Thus preferably each signal in the block diagram of FIG. 2 is carried by a differential pair of connections on the chip, so that differential rf, LO (local oscillator) and IF signals are employed.

Referring now to FIG. 3, this shows a block diagram of a near zero IF receiver 300 (up to the IF stages) which includes an rf integrated circuit 302 incorporating the IF frequency conversion system shown in FIG. 2.

Referring to FIG. 3, the signal paths begin with a set of three off-chip band selection filters 304a, b, c for Band 2 (fm), Band 3, and L-Band respectively. One of these is selected by a multiplexer 306, generally under control of a base band integrated circuit, for further processing. The output of multiplex 306 provides an input 202 to the IF frequency conversion system, in which like elements to those of FIG. 2 are indicated by like reference numerals. The circuitry within dashed line 308 comprises the first local oscillator signal generator 208 of FIG. 2 and, in this preferred embodiment, is implemented by means of a phase locked loop (PLL) including an on-chip LC VCO (voltage control oscillator) with a crystal reference. A conventional PLL arrangement may be employed, but a preferred arrangement is described in the applicant's co-pending UK Patent Application No. ______ filed on the same day as this application, hereby incorporated by reference. Further details of the integrated circuit 302 of FIG. 3 are described below since these are helpful in understanding one application for the circuit of FIG. 2.

As previously described, the IF after downconversion is 1.024 MHz for the DAB inputs (Band 3, L Band), and it is 150 KHz for the FM input (Band 2). After polyphase filtering the signal is upconverted to 2.048 MHz for DAB and 2.198 MHz for FM, and an IF variable gain amplifier and output driver provides a differential ADC drive for a subsequent base band I C. A PLL with on-chip LC VCO and a post divider generates the first LO signal for all bands, and this PLL, the second LO generation and the filter alignment are all reference to the crystal reference frequency (of 16.384, 24.576 or 32.768 MHz).

There are three LNA inputs, one for each frequency band. Each LNA has 40 dB of AGC control range, and a P1 dB of −15 dBm. Without external AGC components the chip can meet the −25 dBm high level input requirements for portable receivers; an off-chip PIN diode attenuator maybe used to extend the input range to −15 or −10 dBm. The rf input filters may provide protection from ESD discharges to an external antenna.

As previously described, the IF filters combine the functions of channel selectivity, anti-alias filtering for the base band ADC and quadrature combining for image rejection. The first IF filter is a four-pole bandpass filter centred at 1.024 MHz, with 3 dB bandwidth of 1.9 MHz to 270 kHz. After the quadrature upconversion to the second IF, additional filtering is used to prevent aliasing. This is achieved with the second IF filter, which has an upper frequency of 2.048 MHz and a bandwidth of 3.6 MHz. A filter alignment circuit may be used to align the centre frequency and bandwidth of all IF filters to the crystal reference frequency. A calibration cycle may be run each time the PLL is re-programmed, or when the PLL or IF circuits are turned on. Periodically, say every half second, an on-die temperature sensor may be employed to take a reading and update the filter tuning.

A first AGC loop controls the rf AGC amplifier and the (optional) external PIN diode attenuator to avoid overloading of the RF and IF circuits; this detects signal levels at the first mixer input and at the first IF filter output. The IF AGC amplifier provides the final gain at the second IF. This is preferably controlled by the baseband IC to give a constant input level to the ADC on the baseband chip.

In a preferred implementation the frequency synthesizer includes an integer-N PLL comprising a fully integrated VCO, prescaler, phase detector, charge pump, reference divider and reference prescaler, and the loop filter is external. The reference divider divides down an externally provided reference frequency to a comparison frequency of 256 kHz for all bands. The VCO output is divided by two for L-band, by 12, 14 or 16 for Band 3 and by 28 or 32 for Band 2. The quadrature output of this programmable divider feeds the quadrature downmixers. This results in a first IF frequency of 1.024 MHz for all DAB bands (IF_{DAB}), and 150 KHz for Band 2 FM mode. The second LO of 1.024 MHz (DAB mode) or 2.048 MHz (FM mode) for the upconverter is divided down from the reference frequency. This results in a second IF frequency of 2.048 MHz for DAB and 2.198 MHz for FM mode. The PLL and post-divider provide a channel frequency resolution of 64 KHz for L-band and Band 3, and a 4 KHz resolution for fine tuning in Band 2.

FIG. 4 shows a block diagram of a DAB 400 receiver incorporating the IF frequency conversion system of FIG. 2. In FIG. 4 like elements to those of FIGS. 2 and 3 are indicated by like reference numerals.

Referring to FIG. 4, the output 224 of AGC 220 is provided to analogue-to-digital converter 402 for digitisation and subsequent coded orthogonal frequency division multiplexed (COFDM) signal demodulation by COFDM demodulator block 404. The output of demodulator 404 is provided to a DAB protocol stack decoder 406, which in turn provides an MPEG datastream to MPEG audio decoder 408 which provides an audio output to stereo DAC 410 and audio amplifiers and speakers 412. A mail machine interface (MMI) 414 interfaces with DAB protocol stack decoder 406 to provide a user keyboard 416 and display 418. These allow a user to interact with the receiver 400 via slave control processor and registers 420.

No doubt many other effective alternatives will occur to the skilled person. For example although embodiments of the described IF frequency conversion system combine the I and Q signals following the second (up-conversion) IF stage, these signals could be processed separately and provided to a pair of ADCs for subsequent digital downconversion and demodulation.

It will be understood that the invention is not limited the described embodiments and encompasses modifications apparent to those skilled in the art lying within the spirit and scope of the claims appended hereto.

1. A low IF radio receiver circuit, the circuit comprising:
an rf input for a received rf signal;
a first local oscillator having a quadrature output to provide a quadrature first local oscillator signal at a first frequency;
a quadrature first mixer coupled to said rf input and to said quadrature output of said first local oscillator and having a quadrature first mixer output, said first mixer and said first local oscillator being configured to provide quadrature mixing of said quadrature first local oscillator signal and said received rf signal to downconvert said received rf signal to a first quadrature IF signal at a first IF frequency;
a bandpass filter coupled to said quadrature first mixer output and having a filtered output to provide a bandpass filtered first IF signal;
a second local oscillator having a second local oscillator output, to provide a second local oscillator signal at a second frequency;
a second mixer coupled to said filtered output of said bandpass filter and to said second local oscillator and having a second mixer output, said second mixer and said second local oscillator being configured to provide mixing of said second local oscillator signal and said bandpass filtered first IF signal to up-convert said bandpass filtered first IF signal to a second IF signal at a second IF frequency, wherein said second IF frequency is greater than said first IF frequency; and
an output coupled to said second mixer output to provide an output signal from said second IF signal.

2. A low IF radio receiver circuit as claimed is claim 1 wherein said filtered output of said bandpass filter comprises a quadrature output, wherein said second local oscillator output comprises a quadrature output and said second local oscillator signal comprises a quadrature signal, wherein said second mixer comprises a quadrature second mixer and said second mixer output comprises a quadrature output.

3. A low IF radio receiver circuit as claimed in claim 2 wherein said bandpass filter comprises a polyphase bandpass filter having a passband response for a target rf signal for reception and an attenuating response for an image signal associated with said target rf signal.

4. A low IF radio receiver circuit as claimed in claim 3 wherein said polyphase bandpass filter has passband substantially cantered on a positive said first IF frequency and an attenuating response, relative to said passband, at a negative said first IF frequency.

5. A low-IF radio receiver circuit as claimed in claim 2 further comprising a combiner coupled to said quadrature second mixer output to combine quadrature components of said second mixer output to provide a single phase combined signal for said output.

6. A low-IF radio receiver circuit as claimed in claim 5 further comprising a low pass filter coupled between an output of said combiner and said output, to low pass filter said combined signal.

7. A low-IF radio receiver circuit as claimed in claim 1 wherein said second IF frequency is substantially twice said first IF frequency.

8. A low-IF radio receiver circuit as claimed in claim 1 wherein said second IF frequency is substantially 2.048 MHz.

9. A low-IF radio receiver circuit as claimed in claim 1 integrated on a single chip.

10. A low-IF radio receiver circuit as claimed in claim 1 for receiving digital audio broadcasts.

11. A low IF radio receiver circuit as claimed in claim 1, further comprising a single phase analog-to-digital converter coupled to said output.

12. A low IF radio receiver circuit as claimed in claim 11 wherein said analogue-to-digital converter has a sampling frequency of substantially four times said second IF frequency.

13. A radio receiver including the low IF radio receiver circuit of claim 1.

14. A method of receiving an rf signal using a low IF receiver, the method comprising:
inputting said rf signal;
downconverting said rf signal to a first, non-zero IF frequency,
said first IF frequency being less than ten times a bandwidth of
said rf signal;
filtering said downconverted rf signal;
upconverting said filtered downconverted rf signal to a second IF frequency, said second IF frequency being higher than said first IF frequency; and
providing said upconverted signal for demodulation.

15. A method as claimed in claim 14 wherein said filtering comprises bandpass filtering to select a target rf signal and attenuate an image rf signal.

16. A method as claimed in claim 14 wherein said downconverting, filtering, and upconverting comprise quadrature downconverting, filtering, and upconverting, and wherein said filtering comprises polyphase filtering.

17. A method as claimed in claim 16 further comprising combining quadrature signals from said upconverting prior to providing said upconverted signal for demodulation.

18. A method as claimed in claim 17 further comprising low pass filtering said combined quadrature signals prior to providing said upconverted signal for demodulation.

19. A method as claimed in claim 14 wherein said second IF frequency is substantially twice said first IF frequency.

20. A method as claimed in claim 14 wherein said rf signal comprises a data signal, and wherein said first IF frequency is less than three times said bandwidth of said rf signal.

21. A method as claimed in claim 14 further comprising converting a signal derived from said upconverted signal into a digital domain for said demodulation, said converting including sampling said signal derived from said upconverted signal at an even integral multiple of said second IF frequency.

22. A low IF signal receiver for receiving an rf signal, said receiver comprising:
means for inputting said rf signal;
means for downconverting said rf signal to a first, non-zero IF frequency, said first IF frequency being less than ten times a bandwidth of said rf signal;
means for filtering said downconverted rf signal;
means for upconverting said filtered downconverted rf signal to a second IF frequency, said second IF frequency being higher than said first IF frequency; and
means for providing said upconverted signal for demodulation.
